(19) United States
(12) Patent Application Publication
(10) Pub. No.: US 2012/0177459 A1
(43) Pub. Date: Jul. 12, 2012

(54) SYSTEM AND METHOD FOR FIXEDLY CONNECTING SHEETS

(75) Inventor: Anders Carlsson, Atvidaberg (SE)

(73) Assignee: EXPANDER SYSTEM SWEDEN AB, Atvidaberg (SE)

(21) Appl. No.: 13/496,247

(22) PCT Filed: Sep. 16, 2010
(86) PCT No.: PCT/SE2010/050995

§ 371 Date: Mar. 15, 2012

(30) Foreign Application Priority Data
Sep. 18, 2009 (SE) 0950686-6

(51) Int. Cl. F16B 5/00; B23P 11/00

(52) U.S. Cl. 411/80.5; 29/525.01

(57) ABSTRACT

There is provided a joint system for joining together at least two sheet portions, comprising a first sheet portion presenting a first recess, a second sheet portion, overlapping the first sheet portion, and presenting a second recess, the first and second recesses being substantially aligned; and a fastener received in said first and second recesses. The fastener is a mainly radially operating fastener.

### TECHNICAL FIELD

This document relates to a system and a method for fixedly connecting sheets, e.g. sheets of metal. The fastener, system and method are particularly suitable for joining together sheets of metal for heavy duty applications, such as in heavy constructions (buildings, bridges etc.), heavy vehicles, ships and the like.

### BACKGROUND

When joining together sheets of metal, e.g. sheets making up the hull of a ship, it is important that the sheets are tightly secured in order to prevent the sheets from moving relative one another.

Conventional fasteners, such as nut and bolt arrangements or rivets are used to fixate or clamp two or more sheets to each other, whereby a bolt or rivet of suitable dimensions is introduced through corresponding holes in the sheets and subsequently secured by nut and optionally one or more washers.

The conventional fasteners are adapted for transferring forces axially, as seen in the longitudinal direction of the bolt or rivet, and to clamp the metal sheets in their normal direction, hereinafter referred to as the axial direction. Radial forces, counteracting relative movement between the sheets in a direction parallel with the planes of the sheets, are provided by the friction between the sheets and between the bolt head, nut and/or washer and its associated sheet. This friction force is a function of the axial force provided by the fastener.

It is important to counteract both axial and radial relative movement between the sheets.

However, the holes in the sheets must also allow for a certain clearance in relation to the bolt, otherwise the bolt will not fit through the hole.

Radial relative movement between the sheets may cause fatigue fractures of the bolt or of the sheets, and also unthreading of the nut, especially when the arrangement is subjected to alternating load directions.

Hence, there is a need for a way to absorb the radial, or shearing, forces and thus to reduce the risk of fatigue fractures and unthreading of the nut, and to prevent macrosliding in the normal plane of the sheets.

### SUMMARY

It is hence an object of the present disclosure to overcome or alleviate at least some of the problems discussed above.

The invention is defined by the appended independent claims, with embodiments being set forth in the dependent claims, in the attached drawings and in the following description.

According to a first aspect of the present solution there is provided a joint system for joining together at least two sheet portions, comprising a first sheet portion presenting a first recess; a second sheet portion, overlapping the first sheet portion, and presenting a second recess, the first and second recesses being substantially aligned; and a fastener received in said first and second recesses. The fastener is a mainly radially operating fastener.

The mainly radially operating fastener comprises: a guide part having an outer substantially conical surface; an expander sleeve, having an inner substantially conical surface, adapted to cooperate with the outer conical surface of the guide part, and an outer surface adapted for engaging a radially adjacent surface of at least one of the first and second recesses; and a clamping arrangement, arranged to provide an axial relative movement between the guide part and the expander sleeve, thus causing the expander sleeve to expand radially.

The mainly radially operating fastener further includes a second outer conical surface and a second expander sleeve operating in opposite direction to said first expander sleeve. The first expander sleeve may be adapted for interaction only with the first recess, and wherein the second expander sleeve is adapted for interaction only with the second recess.

The joint system further comprises a mainly axially operating fastener.

A radially adjacent surface may be the cylindrical surface of a through hole or a blind hole.

The term “conical” is not limited to linearly conical devices, and thus does not exclude the possibility of the conical surface being somewhat convex or concave.

By “axial” is meant along the axis of the guide part and the expander sleeve, thus an “axial relative movement” refers to the movement of the guide part and/or the expander sleeve relative to one another along their axis.

By “radial” is meant in a direction substantially in the plane in which the sheets overlap. The “radial” direction is thus substantially perpendicular to the “axial” direction.

By “mainly radially operating fastener” is understood a fastener providing it's main force in one or more radial directions, e.g. in the plane of a sheet. Such a fastener may however also, via friction, provide an axial force.

By “expand radially” is meant that some portion of the outer surface of the expander sleeve may be moved outwards from the axis so as to eliminate or reduce a play between the outer surface of the expander sleeve and the radially adjacent surface.

By “mainly axially operating fastener” is understood a fastener providing it's main force in a substantially axial direction. Such a fastener may also, via friction, provide forces in one or more radial directions.

By using an expander sleeve arrangement, the play between the outer surface of the fastener and the radially adjacent surface may be eliminated, thus counteracting a relative radial movement between the sheets, and thereby further fixating the sheets relative one another.

The inclusion of a second outer conical surface allows for the use of expander sleeves from opposite sides of the sheets, which for example has the advantage of allowing a reduced hole diameter for any given desirable gradient or angle of inclination, of the first and second conical surfaces.

That the first expander sleeve is adapted for interaction only with the first recess and the second expander sleeve only with the second recess has the advantage of compensating for alignment errors between the recesses, and also for diameter variances and shape differences between the holes.

The use of the mainly axially operating fastener has the advantage of effectively counteracting both axial and radial relative movement between the sheets.

At least one of the recesses may be a through hole.

In this case the “radially adjacent surface” may be referred to as a “hole surface” which would then correspond to the cylindrical walls, defining the through hole, substantially perpendicular to the direction in which the sheets overlap.

The outer surface may be substantially cylindrical.

By “substantially cylindrical” is meant substantially defining the shape of a cylinder, i.e a tube with a substantially uniform cross section along its axis.

This has the advantage of the outer surface of the expander sleeve corresponding to a substantially cylindrical hole surface in the sheet.

The first and second outer conical surfaces may form part of the same guide part or different guide parts.

The first expander sleeve may have a length adapted to correspond to a thickness of the first sheet portion.

The second expander sleeve may have a length corresponding to a thickness of the second sheet portion.

This has the advantage of providing effective interaction of the respective expander sleeve with the corresponding radially adjacent surface of the sheet portions so as to fill or reduce any play there between. It also allows for adapting the expander sleeves to the characteristics of the respective sheet.

The length of the first expander sleeve may be different from the length of the second expander sleeve.

This allows for adapting the sleeves to sheets of different thickness.

The length of the first outer conical surface may be different from the length of the second outer conical surface.

This has the advantage that the respective first and second conical surfaces may be adapted to correspond to the thickness of the first and second sheets.

The guide part and the clamping arrangement may form separate parts.

The guide part may be integrated with the clamping arrangement.

This may be an effective solution in terms of cost, and facilitate handling of the parts.

The clamping arrangement may include bolt and a nut, and optionally one or more washers.

The clamping arrangement may include a pin, which is threaded to receive respective nuts at its ends.

The use of a nut and bolt arrangement may be convenient in that their dimensions may be adapted for use with standard tools, such as wrenches etc.

The joint system may comprise at least two mainly radially operating fasteners and at least two mainly axially operating fasteners.

The joint system may further comprise a third sheet portion.

At least one of the mainly axially operating fasteners may engage all three sheet portions.

At least one of the mainly radially operating fasteners may engage the first and second sheet portions.

At least one of the mainly radially operating fasteners may engage the second and third sheet portions.

At least one of the mainly radially operating fasteners may engage all three sheet portions.

According to a second aspect of the present solution, a method for joining together at least two sheet portions is provided, the method comprising providing a first sheet portion, presenting a first recess; providing a second sheet portion, overlapping the first sheet portion, and presenting a second recess, the first and second recesses being substantially aligned; arranging a mainly radially operating fastener in said first and second recesses, and activating the mainly radially operating fastener to engage the first and second recesses.

The activating step may comprise causing an expander sleeve having an inner substantially conical surface, to move axially relative to an outer conical surface of a guide part, thus causing the expander sleeve to expand radially; whereby an outer surface of the expander sleeve is caused to engage a radially adjacent surface of at least one of the first and second recesses.

The method may further comprise providing a mainly axially operating fastener, arranging said mainly axially operating fastener in respective substantially aligned recesses of the first and second sheet portions, and activating the mainly axially operating fastener to clamp the sheet portions together.

The method may further comprise providing a third sheet portion, whereby said mainly axially operating fastener is arranged to engage said first, second and third sheet portions.

The mainly radially operating fastener may be arranged to only engage said first and second sheet portions.

The mainly radially operating fastener may be arranged to engage said first, second and third sheet portions.

Other objectives, features and advantages of the present solution will appear from the following detailed disclosure, from the attached dependent claims as well as from the drawings.

### BRIEF DESCRIPTION OF THE DRAWINGS

Embodiments of the present solution will now be described, by way of example, with reference to the accompanying schematic drawings in which.

FIG. 1 is a schematic top view of a sheet metal sheet provided with fasteners.

FIG. 2 is a cross sectional view along the line A-A of FIG. 1.

FIG. 3 is an enlarged view of section B of FIG. 2.

FIG. 4 is an enlarged view of section C of FIG. 2.

FIG. 5 is a schematic top view of an embodiment of a sheet metal sheet provided with fasteners.

FIG. 6 is a cross sectional view along the line A-A of FIG. 5.

FIG. 7 is a cross sectional view along the line B-B of FIG. 5.

FIG. 8 is an enlarged view of section C of FIG. 6.

FIG. 9 is an enlarged view of section D of FIG. 5.

FIG. 10 is a perspective view of a fastener.

FIG. 11 is a schematic top view of an embodiment of a sheet metal sheet provided with fasteners.

FIG. 12 is a cross sectional view along the line A-A of FIG. 11.

FIG. 13 is a cross sectional view along the line B-B of FIG. 11.

FIG. 14 is a cross sectional view of a joint system with a fastener joining together three sheet metal sheets.

FIG. 15 is a schematic perspective view of the fastener in FIG. 14.

### DESCRIPTION OF EMBODIMENTS

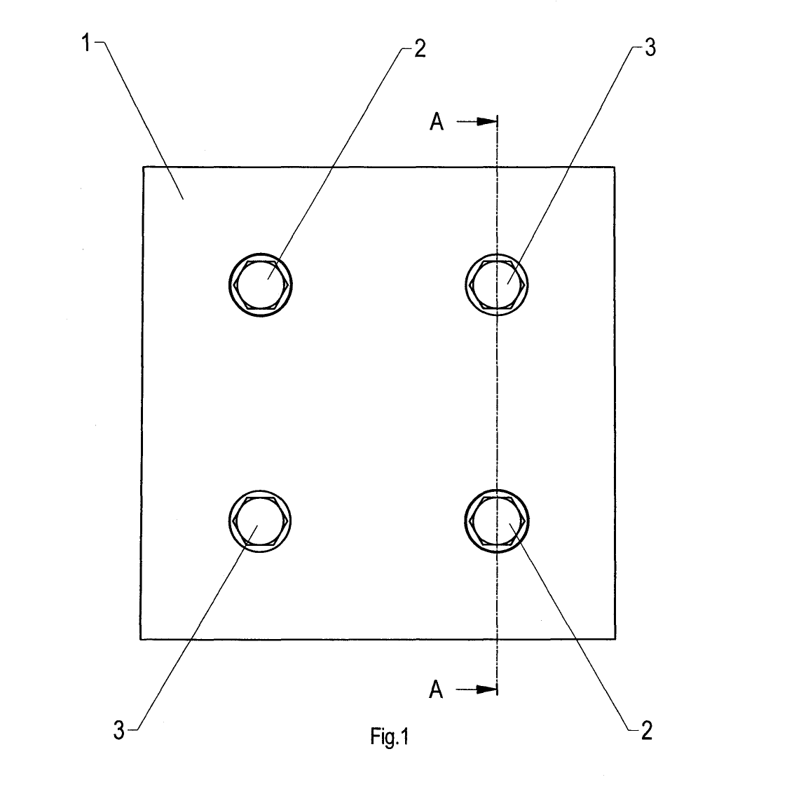

FIG. 1 illustrates a sheet metal sheet portion 1, hereinafter called a sheet, provided with fasteners of two different types, the first fastener 2 is a fastener of the type illustrated in FIGS. 4 and 10, hereinafter called an expander bolt, and the second fastener 3 is a conventional fastener, arranged to operate mainly axially for providing an axial clamping of the sheets.

The conventional fastener is here illustrated in the form of a nut and bolt arrangement shown in FIG. 3, where the nut, bolt head and washers are arranged to interact with the main surfaces of the respective sheet. The washers, and optionally also the nut and/or bolt head have a diameter which is larger than the diameter of the recesses 4, 4′, in which the conventional fastener 3 is arranged.

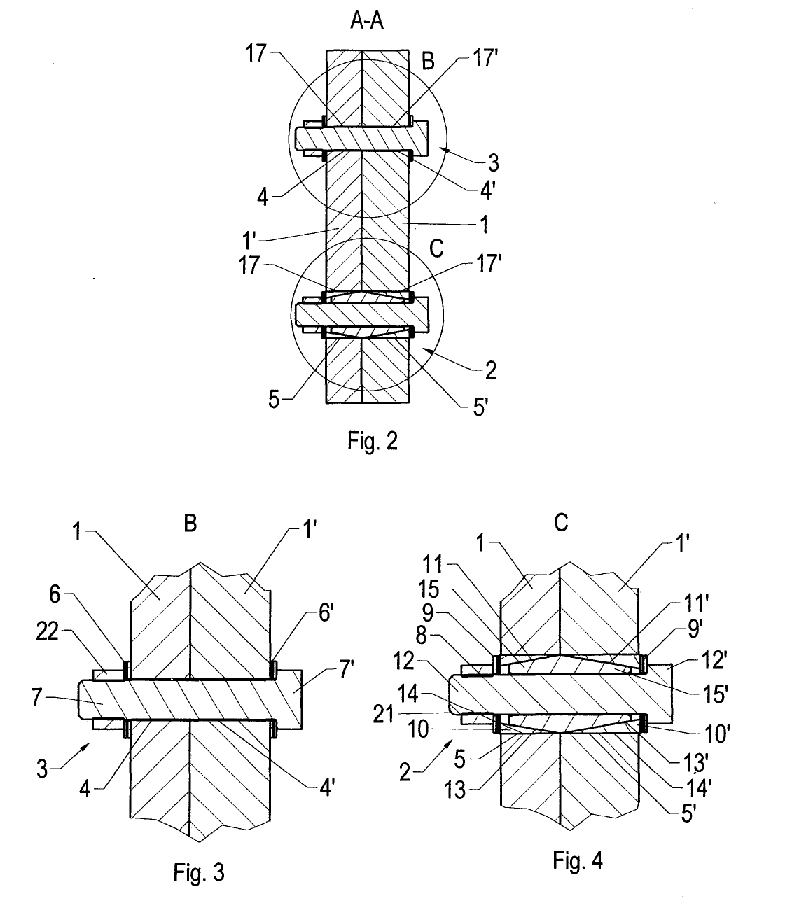

The recesses 4, 4′, 5, 5′ may be through holes as shown in FIGS. 2-4.

In one embodiment, the first sheet portion 1, as shown in FIG. 2, is provided with through holes 4 and 5, corresponding to through holes 4′ and 5′ provided in an adjacent second sheet portion 1′. The through holes are adapted for, that is, are formed to allow for, the introduction of a respective fastener, e.g. a bolt, a pin, a rivet or an expander bolt.

At least one of the holes 4, 4′, 5, 5′ can be replaced with a blind hole, provided that the blind hole is shaped and adapted for interaction with a nut or bolt head, to prevent its rotation, or provided with threads to interact with a threaded portion of a bolt.

In the embodiment shown in FIGS. 1 and 2, the sheets 1 and 1′ are provided with two expander bolts 2 and two conventional bolts 3, that is an equal number of each kind of fastener.

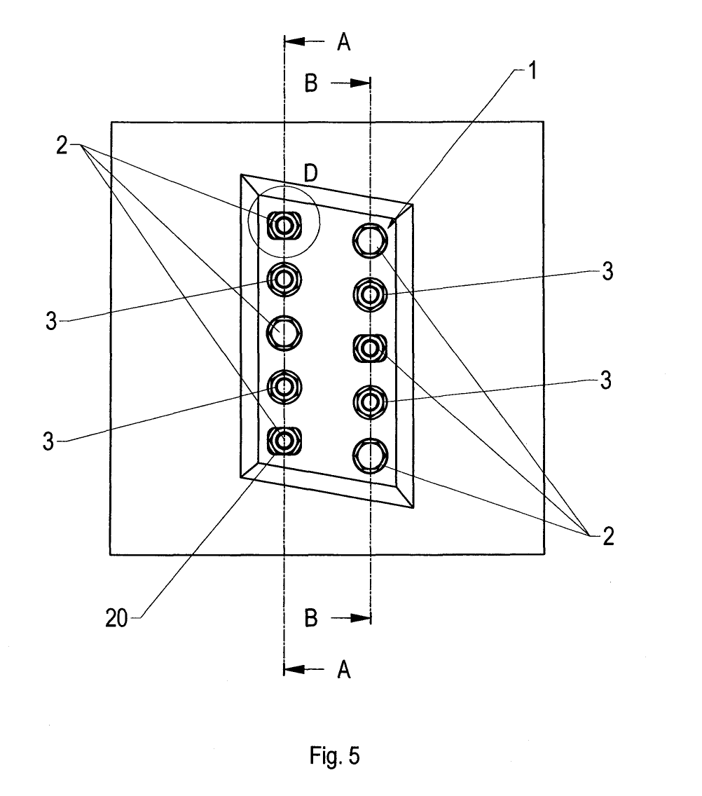

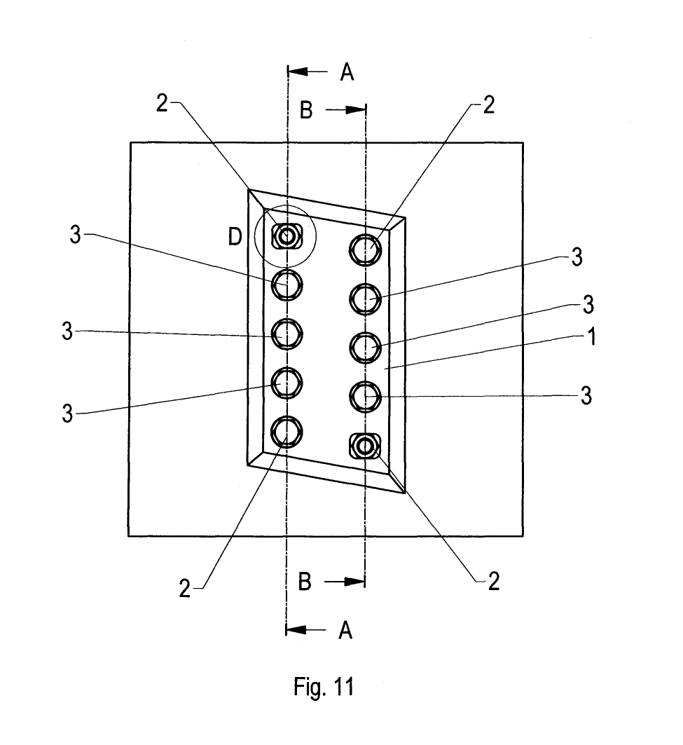

Further embodiments shown in FIG. 5 and FIG. 11 illustrate that the number of expander bolts relative to the number of conventional-type fasteners may vary.

FIG. 2 illustrates the sheets 1 and 1′ wherein fasteners 3 and 2 have been inserted through the holes 4, 4′, 5 and 5′ respectively.

FIG. 3 illustrates a fastener 3, which operates mainly axially, e.g. a bolt 7, inserted through the holes 4, 4′ of the sheets 1, 1′. The bolt 7 is secured on the outer surface of the sheet 1′ by its head 7′, and at the other surface of the sheet 1, by a nut 22. A first washer 6 is provided between the sheet 1 and the nut 22, and a second washer 6′ is provided between the head portion 7′ and the sheet 1′. The nut, bolt, and optionally washers, provide an axial clamping force on the sheets.

FIG. 4 illustrates and expander bolt 2, inserted through the holes 5, 5′ of the sheets 1, 1′. The expander bolt 2 comprises an axially clamping arrangement, which may comprise a bolt 12, a nut 8, and washers 9, 9′, and a guide part 15, and which is arranged to provide an axial force operating only on the parts of the expander bolt. The bolt head 12′, the washers 9, 9′ and the nut 8 present a smaller diameter than the corresponding holes 5, 5′, such that no axial clamping force is provided on the sheets.

The expander bolt further comprises a guide part 15, which is provided with a first outer conical surface 11. An expander sleeve 10 is adapted to cooperate with the outer conical surface 11 of the guide part 15, and is provided with a corresponding, inner conical surface 13. The outer surface of the sleeve 10 may be substantially cylindrical and adapted to fit into the through holes 5, 5′ of the sheets 1, 1′. The length of the sleeve 10 may be adapted to correspond to the thickness of the sheet 1. In particular, it may present a length in the axial direction, which is equal to or less than the thickness of the corresponding sheet.

The guide part 15 may further be provided with a second outer conical surface 11′ and a second expander sleeve 10′ operating in opposite direction to first expander sleeve 10.

The guide part may be provided in one piece with the bolt, or as a separate part.

The expander sleeves 10, 10′ may present at least one axial slit, which facilitates its radial expansion.

A respective washer 9′, 9 may be provided to form an interface between the bolt head 12′ and its associated expander sleeve 10 and between the nut 8 and its associated expander sleeve 10′.

Still with reference to FIG. 4, the operation of the expander bolt will now be described.

Holes 5, 5′ of two sheets 1, 1′ to be joined are aligned. An expander bolt 2 with a guide part 15, expander sleeves 10, 10′ and washers 9, 9′ mounted thereon is inserted through the holes 5, 5′, and the expander sleeves are axially aligned with their associated sheets' thickness.

The nut 8 and bolt 12′ are then activated to compress the expander bolt, thereby causing the expander sleeves 10, 10′ to move axially relative to the guide part or guide parts.

With the expander sleeves 10, 10′ being clamped between the bolt 12 and the respective hole surface, play-free connections are created between the bolt and each of the hole surfaces, counteracting radial relative movement between the sheets.

One or more conventional fasteners may supplement the expander bolt or expander bolts 2 by clamping the sheets in the axial direction.

FIGS. 5-7 illustrate an alternative arrangement where three overlapping sheets 1, 1′, 1″ are joined together by means of a plurality of expander bolts 2 and bolts 3.

FIG. 5 is a schematic top view of the arrangement.

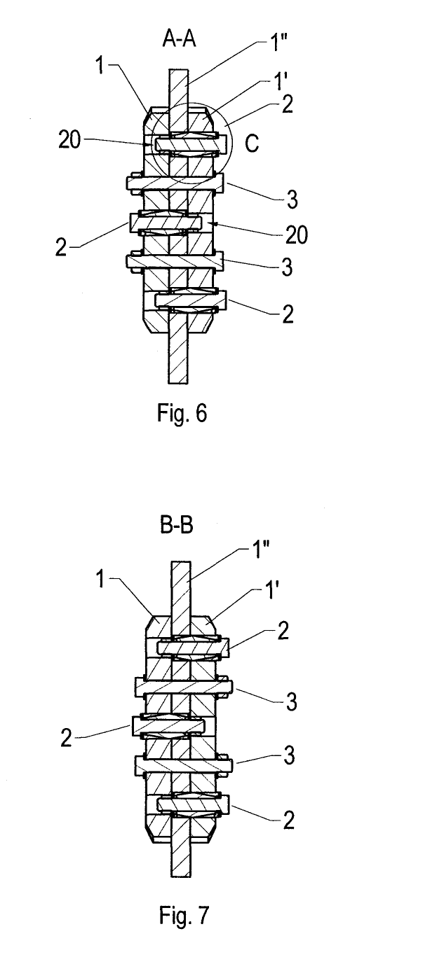

FIGS. 6 and 7 are cross sectional views along the respective lines A-A, and B-B as shown in FIG. 5, illustrating how expander bolts 2 may be used to join a first, second and third sheet 1, 1′, 1″, using a combination of conventional fasteners 3 and expander bolts 2.

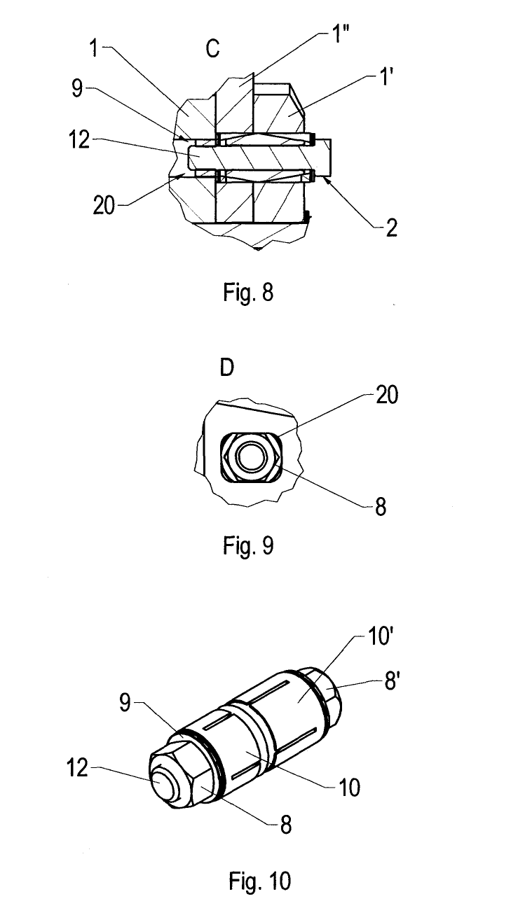

In this embodiment the conventional fasteners may be arranged to extend through all three sheets 1, 1′, 1″, while the expander bolts 2 may be arranged to extend only through two adjacent sheets. Specifically, while some expander bolts 2 extend through the second sheet 1′ and the third, intermediate, sheet 1″, as shown in FIGS. 6 and 8, other expander bolts 2 extend through the first sheet 1 and the third, intermediate, sheet 1″.

As is shown in FIGS. 8 and 9, the nut 8 or bolt head 12′ of the expander bolt 2 may be embedded into a recess 20 of the first sheet 1. The recess may be shaped to counteract rotation of the nut or bolt head, which may facilitate the assembly and activation of the expander bolt 2.

FIG. 10 illustrates an expander bolt 2, comprising a bolt 12, a nut 8, a washer 9 and an expander sleeve 10, and a second expander sleeve 10′ and a second nut 8′.

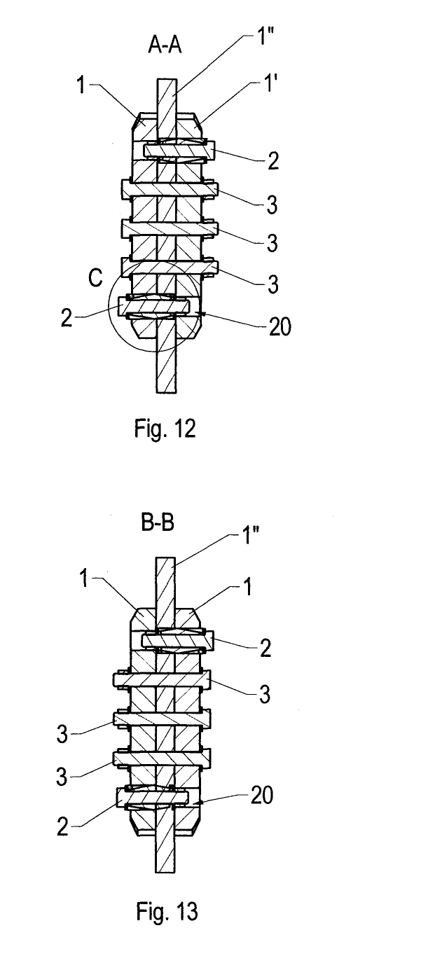

FIGS. 11-13 illustrate yet another embodiment of arranging the expander bolts 2 and conventional fasteners 3 to secure together three sheets. In this embodiment, a higher number of conventional fasteners are used than the number of expander bolts 2.

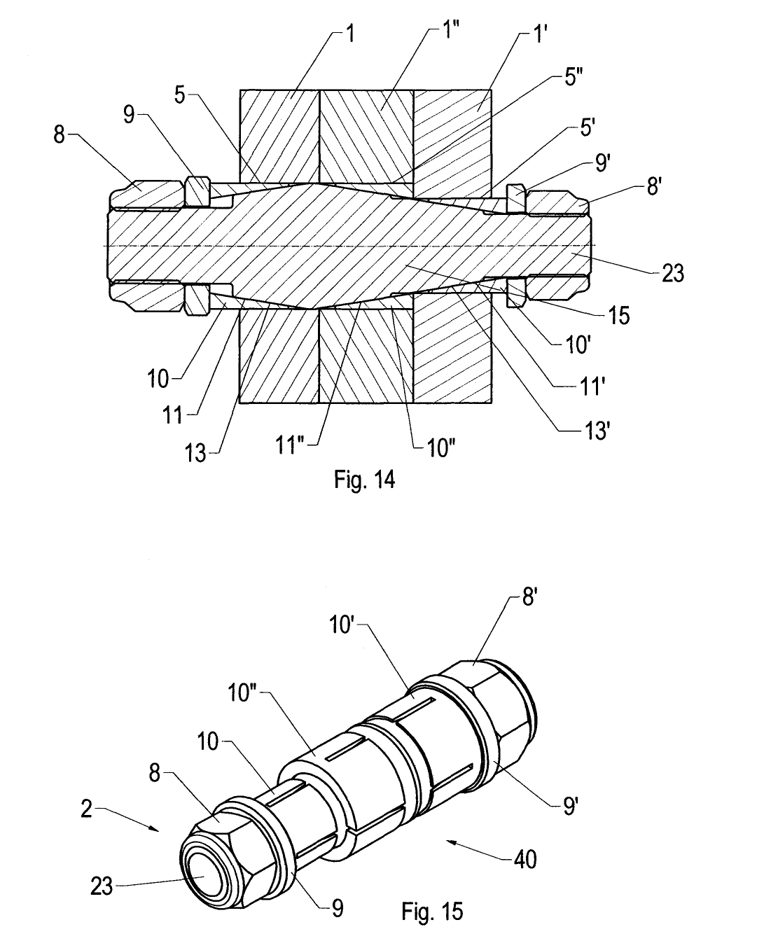

FIG. 14 is a schematic sectional view of a joint system joining together three sheet portions 1, 1′, 1″. The system comprises an expander bolt 2 introduced through aligned recesses in the form of through holes 5, 5′, 5″ of the respective sheets 1, 1′, 1″. The holes 5, 5″ of the sheets 1, 1″ have substantially the same diameter, whereas the hole 5′ of the sheet 1′ has a smaller diameter.

The expander bolt 2 further comprises three expander sleeves 10, 10′, 10″ with inner conical surfaces 13, 13′, 13″ adapted for cooperation with three conical outer surfaces 11, 11′, 11″, of a guide part 15. There is also provided a clamping arrangement comprising a through going pin 23, here forming an integrated part with the guide part 15, arranged for connection with a nut (8, 8′) in each end thereof by means of threading. The clamping arrangement further comprises washers 9, 9′. A main purpose of the clamping arrangement is to provide an axial movement between the respective inner conical surfaces 13, 13′, 13″ of the expander sleeves (10, 10′, 10″) and the corresponding outer conical surfaces 11, 11′, 11″ of the guide part 15.

To join the sheet portions (1, 1′, 1″) the expander sleeve 10″ is placed around the guide part 15. The guide part 15 is then inserted in to the hole 5, further through the hole 5″ and in to the hole 5′, such as to place the expander sleeve 10″ in a position where it's end portion abuts the sheet 1′. The expander sleeve 10″ may then be secured in its position by tightening of the nut 8′ wherein the abutment of the expander sleeve 10″ with the sheet 1′ cooperates with the nut 8′ to clamp the expander sleeve 10″ in a position such that the outer conical surface 11″ and the inner conical surface 13″ cooperate to eliminate, or reduce, any play between the expander sleeve 10″ and the radially adjacent surface of the recess 5″ of the sheet 1″.

The expander sleeve 10 may then be placed in the hole 5 of the sheet 1, and accordingly be secured in a gap eliminating position, by activation of the clamping arrangement by tightening of the nut 8 to provide an axial movement of the expander sleeve 10 relative the outer conical surface 11, causing the expander sleeve 10 to expand radially, so as to eliminate any gap between its outer surface and the inner surface of the recess 5.

The nut 8′ and the corresponding washer 9′ are then removed and the expander sleeve 10′ is placed around the guide part 15, inserted in to the hole 5′, and secured in its respective gap eliminating position by retightening of the nut 8′ acting via the washer 9′.

As can be seen in FIG. 4, an expander bolt having multiple expander sleeves may be arranged so that each expander sleeve only interacts with one corresponding sheet. This has the advantage of compensating for alignment errors between the recesses, and also for diameter variances and shape differences between the holes.

In one embodiment, the outer expander sleeves 10, 10′, may be shorter than the respective thickness of the corresponding sheets 1, 1′. The clamping arrangement may then be arranged so as not to risk abutting the sheets surface when activated. This may be achieved by the using a nut and washer having a smaller outer diameter than the corresponding expander sleeve.

The guide part 15 and the pin 12 may be separate parts. The guide part may have a cylindrical hole along its axis to slidingly receive such a separate pin.

1. A joint system for joining together at least two sheet portions, comprising:
a first sheet portion presenting a first recess;
a second sheet portion, overlapping the first sheet portion, and presenting a second recess, the first and second recesses being substantially aligned; and a fastener received in said first and second recesses;
wherein the fastener is a mainly radially operating fastener, wherein the mainly radially operating fastener comprises: a guide part having an outer substantially conical surface;
an expander sleeve having an inner substantially conical surface, adapted to cooperate with the outer conical surface of the guide part, and an outer surface adapted for engaging a radially adjacent surface of at least one of the first and second recesses; and
a clamping arrangement, arranged to provide an axial relative movement between the guide part and the expander sleeve, thus causing the expander sleeve to expand radially, wherein the mainly radially operating fastener further includes a second outer conical surface and a second expander sleeve operating in opposite direction to said first expander sleeve, wherein the first expander sleeve is adapted for interaction only with the first recess, and wherein the second expander sleeve is adapted for interaction only with the second recess, and
wherein the joint system further comprises a mainly axially operating fastener.

2. The joint system according to claim 1, wherein at least one of the recesses is a through hole.

3. The joint system according to claim 1, wherein the outer surface is substantially cylindrical.

4. The joint system according to claim 1, wherein the first expander sleeve has a length adapted to correspond to a thickness of the first sheet portion.

5. The joint system according to claim 4, wherein the second expander sleeve has a length corresponding to a thickness of the second sheet portion.

6. The joint system according to claim 1, wherein the length of the first expander sleeve is different from the length of the second expander sleeve.

7. The joint system according to claim 1, wherein the length of the first outer conical surface is different from the length of the second outer conical surface.

8. The joint system according claim 1, wherein the guide part and the clamping arrangement form separate parts.

9. The joint system according to claim 1, wherein the guide part is integrated with the clamping arrangement.

10. The joint system according to claim 1, wherein the clamping arrangement includes a bolt and a nut, and optionally one or more washers.

11. The joint system according to claim 1, wherein the clamping arrangement includes a pin, which is threaded to receive respective nuts at its ends.

12. The joint system according claim 1, comprising at least two mainly radially operating fasteners and at least two mainly axially operating fasteners.

13. The joint system according to claim 1, further comprising a third sheet portion.

14. The joint system according to claim 13, wherein at least one of the mainly axially operating fasteners engages all three sheet portions.

15. The joint system according to claim 13, wherein at least one of the mainly radially operating fasteners engages the first and second sheet portions.

16. The joint system according to claim 13, wherein at least one of the mainly radially operating engages the second and third sheet portions.

17. The joint system according to claim 13, wherein at least one of the mainly radially operating fasteners engages all three sheet portions.

18. A method for joining together at least two sheet portions, the method comprising:
providing a first sheet portion presenting a first recess;
providing a second sheet portion, overlapping the first sheet portion, and presenting a second recess, the first and second recesses being substantially aligned; and
arranging a mainly radially operating fastener in said first and second recesses, and activating the mainly radially operating fastener to engage the first and second recesses.

19. The method as claimed in claim 18, wherein said activating step comprises:
causing an expander sleeve having an inner substantially conical surface, to move axially relative to an outer conical surface of a guide part (5), thus causing the expander sleeve to expand radially; and
whereby an outer surface of the expander sleeve is caused to engage a radially adjacent surface of at least one of the first and second recesses.

20. The method according to claim 18, further comprising:
providing a mainly axially operating fastener, arranging said mainly axially operating fastener in respective substantially aligned recesses of the first and second sheet portions, and
activating the mainly axially operating fastener to clamp the sheet portions together.

21. The method as claimed in claim 20, further comprising:
providing a third sheet portion, whereby said mainly axially operating fastener is arranged to engage said first, second and third sheet portions.

22. The method as claimed in claim 21, wherein said mainly radially operating fastener is arranged to only engage said first and second sheet portions.

23. The method as claimed in claim 21, wherein said mainly radially operating fastener is arranged to engage said first, second and third sheet portions.
